(19) United States
(12) Patent Application Publication
(10) Pub. No.: US 2004/0054765 A1
(43) Pub. Date: Mar. 18, 2004

(54) Method and apparatus for accessing multiple system controllers within a computer system

(76) Inventor: Thomas J. Dwyer III, Sunnyvale, CA (US)

Correspondence Address: PARK, VAUGHAN & FLEMING LLP, 508 SECOND STREET, SUITE 201, DAVIS, CA, 95616, US

(21) Appl. No.: 10/243,267

(22) Filed: Sep. 12, 2002

(51) Int. Cl. G06F 15/16

(52) U.S. Cl. 709/223; 709/227

(57) ABSTRACT

One embodiment of the present invention provides a system for efficiently accessing multiple system controllers within a computer system. The system operates by first receiving an administration connection from an administration device at a first system controller within the computer system. The system next determines if the administration connection is directed to a second system controller within the computer system. If so, the system establishes the administration connection by establishing an internal communication link between the first system controller and the second system controller.

### BACKGROUND

1. Field of the Invention

The present invention relates to the process of administering computer systems. More specifically, the present invention relates to a method and an apparatus for accessing multiple system controllers within a computer system to perform system administration operations for the computer system.

2. Related Art

Large enterprise computer systems often contain dozens or even hundreds of processors that operate in concert with numerous peripheral devices to process large computation workloads. These large enterprise computing systems typically include a dedicated processor known as a “system controller” that is responsible for initializing and controlling resources, such as central processing units (CPUs) and peripheral devices, within the computer system.

An enterprise computer system often includes more than one system controller for fault tolerance purposes. These system controllers include substantially identical circuitry and are interchangeable. This allows the computer system to continue operating using a secondary system controller if the primary system controller fails.

A system administrator typically accesses the system controllers to establish the computer system's operating parameters. The system administrator typically accomplishes this by inputting the operating parameters into a terminal device, which is coupled to the computer system through a communication link, such as a dedicated serial communication link or a network connection.

Existing techniques that use these types of communications links to access multiple system controllers have a number of drawbacks. For example, using a dedicated serial communication link presently involves attaching a separate terminal device to each controller, which can greatly increase cost. Alternatively, a single terminal device can be manually switched between inputs to the different controllers. This manual switching technique is time-consuming and inconvenient for the system administrator.

Using a network solution can eliminate both of these problems, because it allows a single terminal device to communicate with each system controller through a computer network. However, this network solution generates a different problem for the administrator. For the terminal device to be able to communicate with a system controller over the network, the system controller needs its own network address, such as an Internet Protocol (IP) address. Providing multiple IP addresses, one for each system controller and one for the server, may not be feasible because the number of IP addresses available to an entity is typically limited.

Hence, what is needed is a method and an apparatus for accessing multiple system controllers within a computer system without the drawbacks listed above.

### SUMMARY

One embodiment of the present invention provides a system for efficiently accessing multiple system controllers within a computer system. The system operates by first receiving an administration connection from an administration device at a first system controller within the computer system. The system next determines if the administration connection is directed to a second system controller within the computer system. If so, the system establishes the administration connection by establishing an internal communication link between the first system controller and the second system controller.

In a variation of this embodiment, the administration connection is received at the first system controller through a direct connection from a terminal device.

In a further variation, the administration connection is received at the first system controller through a network connection from a terminal device.

In a further variation, establishing the internal communication link between the first system controller and the second system controller involves establishing a point-to-point protocol (PPP) link between the first system controller and the second system controller.

In a further variation, establishing the internal communication link between the first system controller and the second system controller involves establishing a proprietary communication link between the first system controller and the second system controller.

In a further variation, upon receiving an administration command that is destined for the second system controller at the first system controller, the system forwards the administration command to the second system controller.

In a further variation, the system forwards responses received at the first system controller from the second system controller to the administration device.

### BRIEF DESCRIPTION OF THE FIGURES

FIG. 1 illustrates a server with multiple system controllers in accordance with an embodiment of the present invention.

FIG. 2 is a flowchart illustrating the process of administering a computer system with multiple system controllers in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Server System

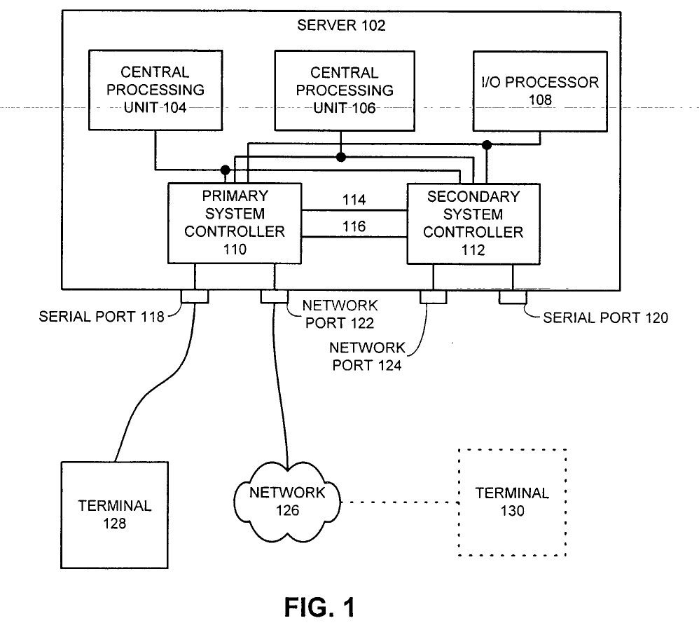

FIG. 1 illustrates a server 102 with multiple system controllers in accordance with an embodiment of the present invention. Server 102 can generally include any computational node including a mechanism for servicing requests from a client for computational and/or data storage resources. Note that the present invention also applies to computer systems other than servers that have multiple system controllers. The present invention, therefore, is not limited to only servers. Server 102 includes central processing units 104 and 106, I/O processor 108, primary system controller 110, and secondary system controller 112.

Central processing unit (CPU) 104 and CPU 106 can generally include any type of processor, including, but not limited to, a microprocessor, a mainframe computer, a digital signal processor, a personal organizer, a device controller, and a computational engine within an appliance. Note that server 102 can contain more or fewer CPUs than shown. CPUs 104 and 106 provide instruction execution for programs executing on server 102.

Input/output (I/O) processor 108 can generally include any type of processor, including, but not limited to, a microprocessor, a mainframe computer, a digital signal processor, a personal organizer, a device controller, and a computational engine within an appliance. I/O processor 108 provides an interface to the I/O ports of server 102.

Primary system controller 110 and secondary system controller 112 are responsible for initializing and controlling the various units within server 102. Note that more than two system controllers may be used. However, one embodiment of the present invention has two system controllers, with one controller configured as primary and the other controller configured as secondary. Note that each system controller has a separate communication path to each of the major functional sections of server 102, such as CPUs 104 and 106 and I/O processor 108.

Normally, primary system controller 110 is responsible for initializing and controlling the various units within server 102, whereas secondary system controller 112 functions as a backup in case primary system controller 110 fails. If primary system controller 110 fails, secondary system controller 112 automatically takes control of server 102. For this failover to be possible, secondary system controller 112 needs to be aware of the current state of server 102. This state information is provided to secondary system controller 112 through internal communication links 114 and 116. Internal communication links 114 and 116 can include any suitable type of communication link. Typically, internal communication links 114 and 116 are serial links, such as RS-232 links. Normally, only one of internal communication links 114 and 116 is active and the other link is a spare.

In addition to current state, primary system controller 110 and secondary system controller 112 share a common configuration, which is set by a system administrator. Primary system controller 110 and secondary system controller 112 include external communication ports, which can be used to set the configuration of the controllers. In FIG. 1, these external communication ports include serial port 118 and network port 122 for primary system controller 110 and serial port 120 and network port 124. Note that server 102 also includes communication ports, such as network ports, to provide services to clients. These ports are not shown.

As shown in FIG. 1, terminal 128 is coupled to serial port 118 of primary system controller 110. Alternatively, terminal 130 can be coupled to network port 122 across network 126. Network 126 can generally include any type of wire or wireless communication channel capable of coupling together computing nodes. This includes, but is not limited to, a local area network, a wide area network, or a combination of networks. In one embodiment of the present invention, network 126 includes the Internet. Terminals 128 and 130 include any device, which can be coupled to a communication port and communicate with primary system controller 110.

An administrator wishing to configure primary system controller 110 and/or secondary system controller 112 can use terminal 128 or terminal 130 to communicate with primary system controller 110. The actions involved in using terminal 128 are described herein. The actions involved in using terminal 130 are substantially identical to the actions using terminal 128. If commands entered on terminal 128 are destined for primary system controller 110, primary system controller 110 receives the commands directly and takes the appropriate action. If commands entered on terminal 128 are destined for secondary system controller 112, however, primary system controller 110 establishes an internal communication link across either internal communication link 114 or 116. This internal communication link can use point-to-point protocol (PPP) or another, possibly proprietary, protocol. After establishing the internal communication link, primary system controller 110 forwards commands from terminal 128 to secondary system controller 112 across the internal communication link, and returns responses from secondary system controller 112 received through the internal communication link to terminal 128.

The administrator can also communicate with components coupled to primary system controller 110 and secondary system controller 112 through terminal 128. When primary system controller 110 receives a command destined for another component, say central processing unit 106, primary system controller 110 passes the command to central processing unit 106 for action. If the communication path between primary system controller 110 and central processing unit 106 is inoperative, primary system controller 110 can route the command through secondary system controller 112, which can then forward the command to central processing unit 106.

Administering a Computer System with Multiple System Controllers

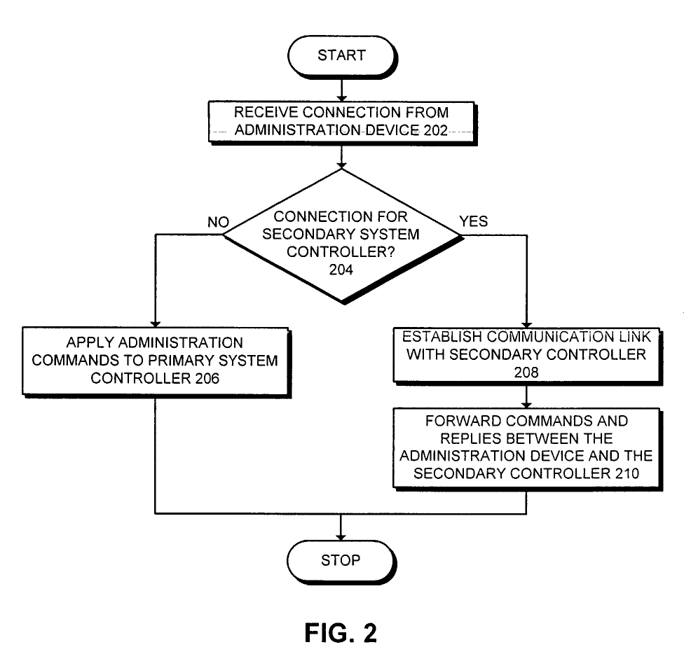

FIG. 2 is a flowchart illustrating the process of accessing multiple system controllers within a computer system in accordance with an embodiment of the present invention. The system starts when primary system controller 110 receives a connection from an administration device such as terminal 128 (operation 202). Next, primary system controller 110 determines whether the connection is directed to secondary system controller 112 (operation 204). If so, primary system controller 110 establishes an internal communication link with secondary system controller 112 (operation 208). Primary system controller 110 then forwards commands from terminal 128 to secondary system controller 112, and also returns responses from secondary system controller 112 to terminal 128 using the internal communication link (operation 210).

If the connection is not directed to secondary system controller 112 at operation 204, primary system controller 110 applies the commands to primary system controller 110 (operation 206).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for accessing multiple system controllers within a computer system, comprising:
receiving an administration connection from an administration device at a first system controller;
determining if the administration connection is directed to a second system controller; and
if the administration connection is directed to the second system controller, establishing the administration connection by establishing an internal communication link between the first system controller and the second system controller.

2. The method of claim 1, wherein receiving the administration connection includes receiving the administration connection through direct connection from a terminal device.

3. The method of claim 1, wherein receiving the administration connection includes receiving the administration connection through a network connection from a terminal device.

4. The method of claim 1, wherein establishing the internal communication link between the first system controller and the second system controller involves establishing a point-to-point protocol (PPP) link between the first system controller and the second system controller.

5. The method of claim 1, wherein establishing the internal communication link between the first system controller and the second system controller involves establishing a proprietary communication link between the first system controller and the second system controller.

6. The method of claim 1, further comprising, upon receiving an administration command that is destined for the second system controller at the first system controller, forwarding the administration command to the second system controller.

7. The method of claim 1, further comprising forwarding responses received at the first system controller from the second system controller to the administration device.

8. The method of claim 1, further comprising, upon receiving an administration command that is destined for the first system controller at the first system controller, applying the administration command to the first system controller.

9. A computer-readable storage medium storing instructions that when executed by a computer cause the computer to perform a method for accessing multiple system controllers within a computer system, the method comprising:
receiving an administration connection from an administration device at a first system controller;
determining if the administration connection is directed to a second system controller; and
if the administration connection is directed to the second system controller, establishing the administration connection by establishing an internal communication link between the first system controller and the second system controller.

10. The computer-readable storage medium of claim 9, wherein receiving the administration connection includes receiving a direct connection from a terminal device.

11. The computer-readable storage medium of claim 9, wherein receiving the administration connection includes receiving a network connection from a terminal device.

12. The computer-readable storage medium of claim 9, wherein establishing the internal communication link between the first system controller and the second system controller involves establishing a point-to-point protocol (PPP) link between the first system controller and the second system controller.

13. The computer-readable storage medium of claim 9, wherein establishing the internal communication link between the first system controller and the second system controller involves establishing a proprietary communication link between the first system controller and the second system controller.

14. The computer-readable storage medium of claim 9, the method further comprising, upon receiving an administration command that is destined for the second system controller at the first system controller, forwarding the administration command to the second system controller.

15. The computer-readable storage medium of claim 9, the method further comprising forwarding responses received at the first system controller from the second system controller to the administration device.

16. The computer-readable storage medium of claim 9, the method further comprising further comprising, upon receiving an administration command that is destined for the first system controller at the first system controller, applying the administration command to the first system controller.

17. An apparatus that facilitates accessing multiple system controllers within a computer system, comprising:
a receiving mechanism that is configured to receive an administration connection from an administration device at a first system controller;
a determining mechanism that is configured to determine if the administration connection is directed to a second system controller; and
a link establishing mechanism, wherein if the administration connection is directed to the second system controller, the link establishing mechanism is configured to establish an the administration connection by establishing an internal communication link between the first system controller and the second system controller,.

18. The apparatus of claim 17, wherein receiving the administration connection includes receiving a direct connection from a terminal device.

19. The apparatus of claim 17, wherein receiving the administration connection includes receiving a network connection from a terminal device.

20. The apparatus of claim 17, wherein establishing the internal communication link between the first system controller and the second system controller involves establishing a point-to-point protocol (PPP) link between the first system controller and the second system controller.

21. The apparatus of claim 17, wherein establishing the internal communication link between the first system controller and the second system controller involves establishing a proprietary communication link between the first system controller and the second system controller.

22. The apparatus of claim 17, further comprising a forwarding mechanism that is configured to forward an administration command to the second system controller, upon receiving the administration command that is destined for the second system controller at the first system controller.

23. The apparatus of claim 17, further comprising a forwarding mechanism that is configured to forward responses received at the first system controller from the second system controller to the administration device.

24. The apparatus of claim 17, further comprising an application mechanism that is configured to apply administration commands to the first system controller that are received at the first system controller and destined for the first system controller.
